(19) United States
(12) Patent Application Publication
(10) Pub. No.: US 2019/0151176 A1
(43) Pub. Date: May 23, 2019

(54) HOSPITAL BED SHEET SYSTEM

(71) Applicant: Jennifer Zeigler, Lucerne Valley, CA (US)

(72) Inventor: Jennifer Zeigler, Lucerne Valley, CA (US)

(21) Appl. No.: 16/194,253

(22) Filed: Nov. 16, 2018

Related U.S. Application Data
(60) Provisional application No. 62/588,293, filed on Nov. 17, 2017.

(51) Int. Cl. A61G 7/10

(52) U.S. Cl. CPC A61G 7/1015; B66D 1/26

(57) ABSTRACT

A hospital bed sheet system including an automated tilting component structured and arranged to elevate a patient on demand and alleviate pressure to specific points of the body to allow a bedridden patient to automatically and independently raise upward and move themselves into a comfortable position without having to wait on assistance, thus immediately making the patient more comfortable, while preventing the formation of bed sores, in a manner that is safe for both the patient and the health care provider.

### CROSS-REFERENCE TO RELATED APPLICATION

The present application is related to and claims priority from prior provisional application Ser. No. 62/588,293, filed Nov. 17, 2017 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of lifting devices and more specifically relates to a hospital bed sheet system comprising an automated tilting component structured and arranged to elevate a patient on demand and alleviate pressure to specific points of the body to allow a bedridden patient to automatically and independently raise upward and move themselves into a comfortable position without having to wait on assistance, thus immediately making the patient more comfortable, while preventing the formation of bed sores, in a manner that is safe for both the patient and the health care provider.

### 2. Description of the Related Art

Millions of Americans visit doctor's offices, clinics and hospitals every year. For those who must undergo surgical procedures or embark on an overnight or extended hospital stay, the patient is typically assigned a hospital bed on which to recuperate and rest during their time in the hospital. Usually boasting various settings with which to raise the head or foot of the bed, these beds are designed with patient comfort in mind and are a crucial element in any patient ward or room. For those patients who suffer serious illness, paralysis or other types of limited mobility brought on by medical conditions or age, the vast majority of time is spent confined to a bed.

Unfortunately, because so much time is spent in a one position, patients confined to continual bed rest are at serious risk of developing bed sores. Bedsores, more properly known as pressure ulcers or “decubitus” ulcers are painful lesions caused by many factors such as: unrelieved pressure, friction, humidity, temperature, age, continence and medication. While bedsores can occur on any part of the body, these lesions are particularly prevalent over bony or cartilaginous areas such as the sacrum, elbows, knees and ankles. Although preventable and completely treatable if found early, bedsores can lead to dangerous infections and are often fatal, even under the auspices of medical care.

Various attempts have been made to solve problems found in lifting device art. Among these are found in: U.S. Pat. No. 5,553,335 to Veli-Tapani Lahtinen; U.S. Pub. No. 2005/0138727 to John Faux et al.; and U.S. Pat. No. 4,644,595 to R. A. Daniel. This prior art is representative of lifting devices for aiding in the lifting of bed ridden patients.

Ideally, a hospital bed sheet system should be user-friendly and safe in-use and,yet would operate reliably and be manufactured at a modest expense. Thus, a need exists for a hospital bed sheet system comprising an automated tilting component structured and arranged to elevate a patient on demand and alleviate pressure to specific points of the body to allow a bedridden patient to automatically and independently raise upward and move themselves into a comfortable position without having to wait on assistance, thus immediately making the patient more comfortable, while preventing the formation of bed sores, in a manner that is safe for both the patient and the health care provider and to avoid the above-mentioned problems.

### BRIEF SUMMARY OF THE INVENTION

In view of the foregoing disadvantages inherent in the known lifting devices art, the present invention provides a novel Hospital Bed Sheet System. The general purpose of the present invention, which will be described subsequently in greater detail is to provide a hospital bed sheet system comprising an automated tilting component structured and arranged to elevate a patient on demand and alleviate pressure to specific points of the body to allow a bedridden patient to automatically and independently raise upward and move themselves into a comfortable position without having to wait on assistance, thus immediately making the patient more comfortable, while preventing the formation of bed sores, in a manner that is safe for both the patient and the health care provider.

A hospital bed sheet system comprising: a first frame; a second frame; a first roller: a second roller: a bed sheet; and a handle. Wherein the first frame is adapted to be attached to a first end of a bed frame. Wherein the second frame is adapted to be attached to a second end of a bed frame spaced and opposite from the first end. Wherein the first roller is rotatably attached to the first frame. Wherein the second roller is rotatably attached to the second frame. Wherein the bed sheet is elongated and connected at opposite ends between the first roller and the second roller. Wherein the handle is connected to the first roller and is adapted to be rotated to thereby rotate the first roller and thereby roll the bed sheet off from the second roller and onto the first roller. Wherein the hospital bed sheet system is adapted such that when a patient is placed upon the hospital bed sheet system the handle can be used to roll the bed sheet off from the second roller and onto the first roller and thereby aid in moving the patient upon a bed placed upon the bed frame.

A hospital bed system is also disclosed comprising: a hospital bed and the hospital bed sheet system. The hospital bed includes: a base; a bed frame including a first end and a second end; and a mattress. Wherein the base is adapted to movably hold a bed frame above a supporting surface. Wherein the second end is spaced and located opposite from the first end. Wherein the bed frame is securely and movably connected to the base. Wherein the mattress is adapted to be placed upon the bed frame.

The present invention holds significant improvements and serves as a hospital bed sheet system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a Hospital Bed Sheet System, constructed and operative according to the teachings of the present invention.

FIG. 1 shows a perspective view illustrating a hospital bed sheet system according to an embodiment of the present invention.

FIG. 2 is a perspective view illustrating a handle connected to the first roller of the hospital bed sheet system according to an embodiment of the present invention of FIG. 1.

FIG. 3 is a perspective view illustrating a hospital bed system according to an embodiment of the present invention of FIG. 1.

FIG. 4 is a perspective view illustrating the hospital bed system in an in-use condition according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a lifting devices and more particularly to a hospital bed sheet system comprising an automated tilting component structured and arranged to elevate a patient on demand and alleviate pressure to specific points of the body to allow a bedridden patient to automatically and independently raise upward and move themselves into a comfortable position without having to wait on assistance, thus immediately making the patient more comfortable, while preventing the formation of bed sores, in a manner that is safe for both the patient and the health care provider.

Generally speaking, the hospital bed sheet system comprising a novel product offering consumer a practical solution to the aforementioned challenges. As the name implies, the hospital bed sheet system comprises a specially designed hospital bed sheet system which can be automatically adjusted to tilt up or down as well as programmed to periodically adjust, thus alleviating pressure to various points of the body.

The frame of the hospital bed sheet system could be fabricated of a durable metal material, with dual frames positioned at each end of a bed. A sturdy yet soft cotton sheet would be stretched between these frames, with a spindle to roll the sheet in and out as the product is used. This sheet, upon which the patient would lie, would measure approximately 120″ in length and 36″ in width. However, larger sizes could be made available. The most notable aspect of the hospital bed sheet system, however, is found in the inclusion of an automated tilting system built into the bed frame.

Configured with hydraulically enhanced adjustability, the hospital bed sheet system would offer a remote-control device that, with the simple pressing of a button, will tilt the bottom frame upward, elevating the feet; the top frame would also tilt upward so that the head is elevated. As an additional consideration, this product could be programmed to automatically tilt in each direction at evenly spaced intervals. As such, the easy movement inherent in the hospital bed sheet system would continuously shift the body, thus serving to vastly reduce pressure to specific areas and, in turn, greatly reduce the risk of bedsores. If needed, a manual crank would be provided to operate the system. A replacement sheet would also be provided in case the primary sheet is soiled.

The hospital bed sheet system would provide medical professionals a simplified way in which to quickly make patients more comfortable and prevent bedsores from occurring in bedridden patients. A specially designed system featuring an automated tilting component that serves to alleviate pressure to specific points of the body, the hospital bed sheet system would reduce the strain and stress placed on bony or cartilaginous areas that can occur as a result of long hours spent bed bound. With painful bedsores effectively eliminated, the dangerous associated infections would also be eradicated, thus resulting in a healthier and happier patient.

Eliminating the need to continuously turn and reposition the patient, simply in order to alleviate pressure points, the hospital bed sheet system is a practical product which would enable caregivers to focus on other, more important aspects of care. Moreover, this product would help prevent injuries to caregivers that can result from manually turning heavy patients. And, the patient would certainly appreciate that they could shift themselves simply by using a remote control. Reasonably priced, the hospital bed sheet system should be well received by health care professionals and their patients, an extremely sizable market potential.

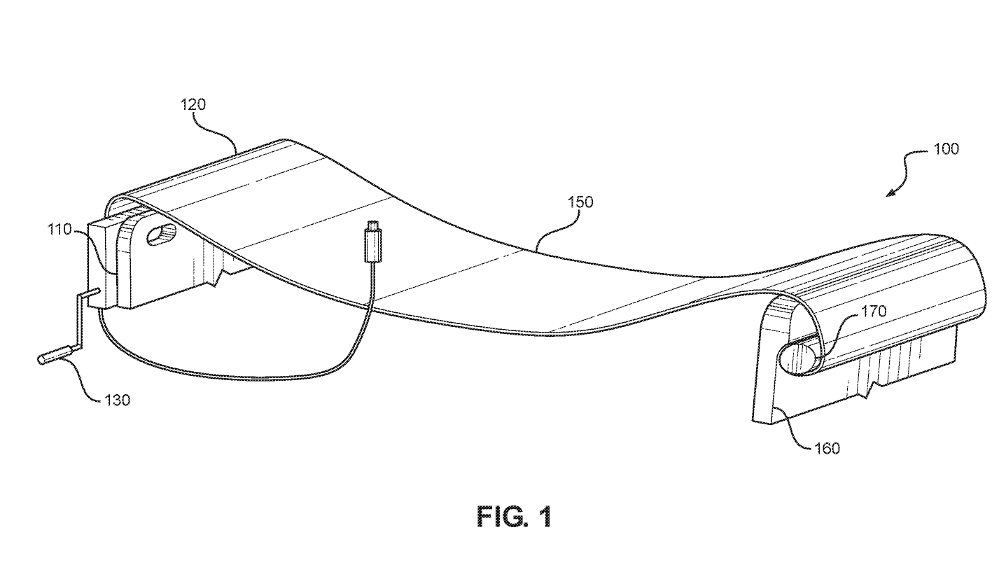

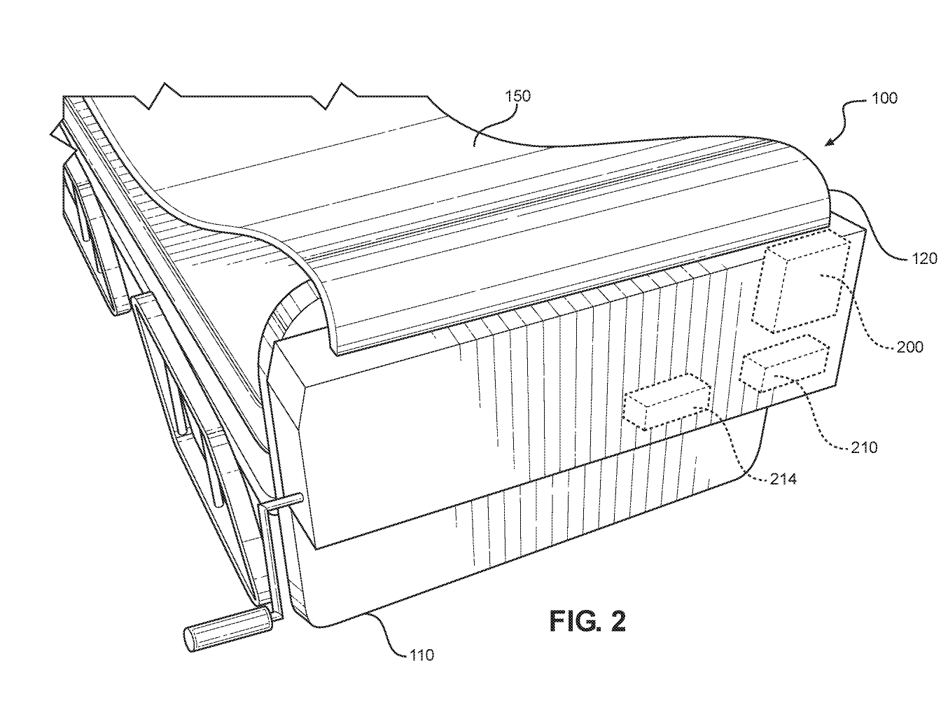

Referring to the drawings by numerals of reference there is shown in FIGS. 1-2, perspective views illustrating hospital bed sheet system 100 according to an embodiment of the present invention.

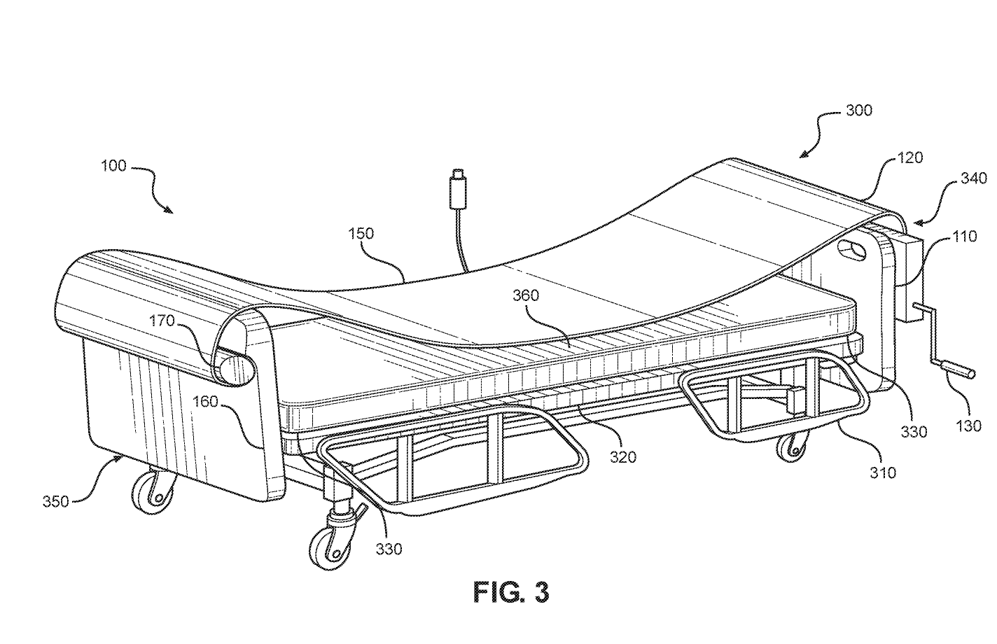

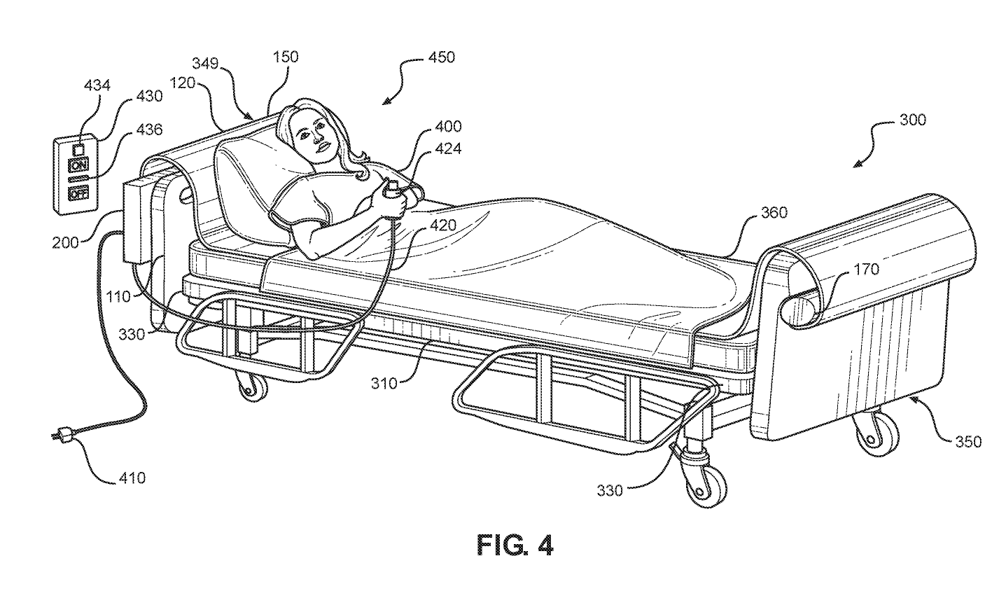

Hospital bed sheet system 100 is disclosed herein in a preferred embodiment comprising: first frame 110; second frame 160; first roller 120: second roller 170: bed sheet 150; and handle 130. Wherein first frame 110 is adapted to be attached to first end 340 of bed frame 330 as shown in FIGS. 3 and 4. Wherein second frame 160 is adapted to be attached to second end 350 of bed frame 330 spaced and opposite from first end 340 also shown in FIGS. 3 and 4. Wherein first roller 120 is rotatably attached to first frame 110. Wherein second roller 170 is rotatably attached to second frame 160. Wherein first frame 110 and second frame 160 are formed from a material chosen from a group of materials consisting of steel and aluminum.

Wherein bed sheet 150 is elongated and connected at opposite ends between first roller 120 and second roller 170. Wherein bed sheet 150 is formed from a material chosen from a group of materials consisting of cotton and nylon. Wherein bed sheet 150 is formed having dimensions including 120 inches in length and 36 inches in width.

Wherein handle 130 is connected to first roller 120 and is adapted to be rotated to thereby rotate first roller 120 and thereby roll bed sheet 150 off from second roller 170 and onto first roller 120. Wherein hospital bed sheet system 100 is adapted such that when patient 400 is placed upon hospital bed sheet system 100 handle 130 can be used to roll bed sheet 150 off from second roller 170 and onto first roller 120 and thereby aid in moving patient 400 upon bed 310 placed upon bed frame 330 as shown in in-use condition 450 of FIG. 4.

Hospital bed sheet system 100 further comprises motor member 200 attached to first frame 110 and first roller 120 and adapted to rotate first roller 120 and thereby roll bed sheet 150 off from second roller 170 and onto first roller 120. Hospital bed sheet system 100 further comprises power source 210 attached to first frame 110 and electrically connected to and adapted to supply power to motor member 200. Wherein power source 210 is formed as a rechargeable battery 214 as shown in FIG. 2. Wherein power source 200 is formed as electrical power cord 410 adapted to connect with an external power source. Wherein motor member 200 includes elongated control cord 420 attached thereto and control button 424 located on a distal end of control cord 420 adapted to turn motor member 200 on and off as shown in FIG. 4.

Referring now to FIGS. 3 & 4, showing perspective views illustrating hospital bed system 300 according to an embodiment of the present invention.

Hospital bed system 300 is also disclosed comprising: hospital bed 310 and hospital bed sheet system 100. Hospital bed 310 includes: base 320; bed frame 330 including first end 340 and second end 350; and mattress 360. Wherein base 320 is adapted to movably hold bed frame 330 above a supporting surface. Wherein second end 350 is spaced and located opposite from first end 340. Wherein bed frame 330 is securely and movably connected to base 320. Wherein mattress 360 is adapted to be placed upon bed frame 330. Wherein bed frame 330 is pivotally connected to base 320 and adapted to be removably held in a plurality of chosen tilted positions with respect to base 320. Wherein hospital bed 310 further includes motor member 324 mechanically connected between base 320 and bed frame 330 and is adapted to move and hold bed frame 330 into any of the plurality of chosen tilted positions with respect to base 320.

Hospital bed system 300 further comprising remote controller 430 adapted to turn on and off motor member 200 of hospital bed sheet system 100 to rotate first roller 120 and thereby roll bed sheet 150 off from second roller 170 and onto first roller 120, and is adapted to control motor member 324 of hospital bed 310 to move and hold bed frame 330 into any of the plurality of chosen tilted positions with respect to base 320. Wherein remote controller 430 includes computer components 434 encoded with software 436 and adapted such that it can be programmed to automatically tilt bed frame 330 in multiple directions and at evenly spaced intervals.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A hospital bed sheet system comprising:
a first frame;
wherein said first frame is adapted to be attached to a first end of a bed frame;
a second frame;
wherein said second frame is adapted to be attached to a second end of a bed frame spaced and opposite from said first end;
a first roller:
wherein said first roller is rotatably attached to said first frame;
a second roller:
wherein said second roller is rotatably attached to said second frame;
a bed sheet;
wherein said bed sheet is elongated and connected at opposite ends between said first roller and said second roller; and
a handle;
wherein said handle is connected to said first roller and is adapted to be rotated to thereby rotate said first roller and thereby roll said bed sheet off from said second roller and onto said first roller;
wherein said hospital bed sheet system is adapted such that when a patient is placed upon said hospital bed sheet system said handle can be used to roll said bed sheet off from said second roller and onto said first roller and thereby aid in moving said patient upon a bed placed upon said bed frame.

2. The hospital bed sheet system of claim 1, further comprising a motor member attached to said first frame and said first roller and adapted to rotate said first roller and thereby roll said bed sheet off from said second roller and onto said first roller.

3. The hospital bed sheet system of claim 2, further comprising a power source attached to said first frame and electrically connected to and adapted to supply power to said motor member.

4. The hospital bed sheet system of claim 3, wherein said power source is formed as a rechargeable battery.

5. The hospital bed sheet system of claim 3, wherein said power source is formed as an electrical power cord adapted to connect with an external power source.

6. The hospital bed sheet system of claim 1, wherein said bed sheet is formed from a material chosen from a group of materials consisting of cotton and nylon.

7. The hospital bed sheet system of claim 1, wherein said first frame and said second frame are formed from a material chosen from a group of materials consisting of steel and aluminum.

8. The hospital bed sheet system of claim 1, wherein said bed sheet is formed having dimensions including 120 inches in length and 36 inches in width.

9. The hospital bed sheet system of claim 2, wherein said motor member includes an elongated control cord attached thereto and a control button located on a distal end of said control cord adapted to turn said motor member on and off.

10. A hospital bed system comprising:
a hospital bed including:
a base;
wherein said base is adapted to movably hold a bed frame above a supporting surface;
a bed frame including:
a first end; and
a second end;
wherein said second end is spaced and located opposite from said first end;
wherein said bed frame is securely and movably connected to said base; and
a mattress;
wherein said mattress is adapted to be placed upon said bed frame; and
a hospital bed sheet system comprising:
a first frame;
wherein said first frame is removably attached to said first end of said bed frame;
a second frame;
wherein said second frame is removably attached to said second end of said bed frame spaced and opposite from said first end;
a first roller:
wherein said first roller is rotatably attached to said first frame;
a second roller:
wherein said second roller is rotatably attached to said second frame;
a bed sheet;
wherein said bed sheet is elongated and connected at opposite ends between said first roller and said second roller, and is adapted to cover a top surface of said mattress; and
a handle;
wherein said handle is connected to said first roller and is adapted to be rotated to thereby rotate said first roller and thereby roll said bed sheet off from said second roller and onto said first roller;
wherein said hospital bed sheet system is adapted such that when a patient is placed upon said hospital bed system said handle can be used to roll said bed sheet off from said second roller and onto said first roller and thereby aid in moving said patient upon said hospital bed.

11. The hospital bed system of claim 10, wherein said hospital bed sheet system further comprises a motor member attached to said first frame and said first roller and adapted to rotate said first roller and thereby roll said bed sheet off from said second roller and onto said first roller.

12. The hospital bed system of claim 11, wherein said hospital bed sheet system further comprises a power source attached to said first frame and electrically connected to and adapted to supply power to said motor member.

13. The hospital bed system of claim 12, wherein said power source is formed as a rechargeable battery.

14. The hospital bed system of claim 12, wherein said power source is formed as an electrical power cord adapted to connect with an external power source.

15. The hospital bed system of claim 11, wherein said motor member includes an elongated control cord attached thereto and a control button located on a distal end of said control cord adapted to turn said motor member on and off.

16. The hospital bed system of claim 11, wherein said bed frame is pivotally connected to said base and adapted to be removably held in a plurality of chosen tilted positions with respect to said base.

17. The hospital bed system of claim 16, wherein said hospital bed further includes a motor member mechanically connected between said base and said bed frame and is adapted to move and hold said bed frame into any of said plurality of chosen tilted positions with respect to said base.

18. The hospital bed system of claim 17, further comprising a remote controller adapted to turn on and off said motor member of said hospital bed sheet system to rotate said first roller and thereby roll said bed sheet off from said second roller and onto said first roller, and is adapted to control said motor member of said hospital bed to move and hold said bed frame into any of said plurality of chosen tilted positions with respect to said base.

19. The hospital bed system of claim 18, wherein said remote controller includes computer components encoded with software and adapted such that it can be programmed to automatically tilt said bed frame in multiple directions and at evenly spaced intervals.
